(19) United States
(12) Patent Application Publication
(10) Pub. No.: US 2023/0333293 A1
(43) Pub. Date: Oct. 19, 2023

(54) OPTICAL SECURITY FEATURE

(71) Applicant: Precision Converting Technologies, LLC, Hudson, WI (US)

(72) Inventors: Peter J. Freyholtz, Hudson, WI (US); James P. Endle, New Richmond, WI (US)

(21) Appl. No.: 17/882,812

(22) Filed: Aug. 8, 2022

Related U.S. Application Data
(60) Provisional application No. 63/331,353, filed on Apr. 15, 2022.

(51) Int. Cl. G02B 5/08; B42D 25/425; B42D 25/351; B42D 25/36; B42D 25/45

(52) U.S. Cl. CPC G02B 5/0816; B42D 25/351; B42D 25/36; B42D 25/425; B42D 25/45; G02B 5/0284

(57) ABSTRACT

A security feature comprising a transparent colored mirror film (CMF) having a diffuse reflector on one surface and identifying print on another surface in such a way that at least four different colors are produced during use in authentication applications.

### RELATED APPLICATIONS

This application claims priority to U.S. Provisional Pat. Application No. 63/331,353, filed Apr. 15, 2022, the entire contents of which are incorporated herein by reference.

### TECHNICAL FIELD

This disclosure relates generally to optical security features that may be useful to authenticate items such as documents, identification cards, monetary currency, etc., and/or to thwart passing off of counterfeit goods.

### BACKGROUND

The prevalence of counterfeit products and documents is a known problem. The use of inexpensive, high quality color copiers, printers and scanners, as well as other reproduction techniques, have enabled counterfeiters to reproduce the authentication features of many items. In addition, the prevalence of low-cost, simple hologram origination has greatly reduced the value of holograms as a security feature. Because of these advancements, currency, security labels, and identification documentation have been subject to counterfeiting using similar technologies.

Items that may be the subject of attempted counterfeiting include certain types of documents (e.g., passports, identification cards, drivers’ licenses, currency, title documents, etc.) and certain consumer goods (e.g., “knock-offs” of brand name items). If a document is to be protected from counterfeiting by using a security laminate, coating or covering a portion of the document for example, the laminate should allow the contents of the document to be seen through the laminate. The security laminate should also be difficult to copy. In addition, security labels used for brand protection and warranty fraud prevention must be relatively simple or easy to authenticate (e.g., preferably without requiring the use of specific tools or equipment) and difficult to replicate or simulate. Examples of technologies used in this space to protect from counterfeiting include holograms, color-shifting inks and foils, and floating images and other micro-optics features. However, all these features have limitations in either ease of simulation/replication, difficulty of authentication, or complex, expensive manufacturing processes. There is an ongoing need for relatively inexpensive security features that are simple to authenticate (for example, by simple tilting or rotating of the feature), yet difficult to simulate or replicate.

An optical effect that has been used to thwart attempts at counterfeiting is angularly sensitive reflective color filtration. This effect occurs when a layer of material acts as a color filter, reflecting incident light in one wavelength range and transmitting light in another wavelength range, with the wavelength ranges of reflection and transmission varying with changes in the incidence angle of the light. Typically, materials of this sort are made up of many thin layers (sometimes referred to as “microlayers”), each layer having a thickness on the order of one quarter of the wavelength of visible light, so they are often referred to generally as quarter-wave interference stacks. They are typically made of absorber/dielectric/reflector constructions or consist of layers of alternating ceramics, each with a different index of refraction. Both of these materials are typically ground into powder, mixed with binder, and printed onto security documents as optically variable inks (“OVI”), which can produce striking colors but are typically not transparent. Another type of color-shifting material includes diffractive effects such as found in holograms, which rely on very small (e.g., sub-micron) structures that produce color, and which can provide stunning visual images but is typically expensive to originate. Another such color-shifting material is Clear to Cyan™ (“C2C”) film made by the 3M Company, which is a colored mirror film (“CMF”) made by multilayer optical film (“MOF”) technology described in U.S. Pat. No. 5,882,774 to Jonza et al. (“Jonza”). C2C film reflects infrared in the normal direction and red in the off-angle direction, so to the human visual system, it appears clear when viewed over a white background and cyan as it is viewed obliquely.

### SUMMARY

This disclosure describes a security feature comprising a transparent colored mirror film (CMF) having a diffuse reflector on one surface and identifying print on an opposite surface in such a way that at least four different (distinct) colors are produced during use in authentication applications.

In some embodiments, a security feature (authentication device) includes a colored mirror film (“CMF”) layer, having a first major surface and a second major surface opposite the first major surface. The CMF layer may comprise a multilayer optical film (“MOF”) extending from the first major surface to the second major surface, the MOF comprising alternating first and second optical polymeric layers, where each of the first layers has a first refractive index, and each of the second layers has a second refractive index that is different from the first refractive index. A scattering layer is disposed on a surface of the CMF (either the first or second major surface of the CMF layer). A print layer is disposed either on the second major surface of the CMF layer (e.g., when the scattering layer is disposed on the first major surface of the CMF layer), or on the scattering layer (e.g., when the scattering layer is disposed on the second major surface of the CMF layer). The combination of diffuse scattering layer, CMF, and print provides optical effects such that at least four distinct colors will be visible to an observer as the authentication device is tilted from a normal angle to the observer to a shift angle from the observer.

### BRIEF DESCRIPTION OF DRAWINGS

The patent or application file contains at least one drawing executed in color. Copies of this patent or patent application publication with color drawing(s) will be provided by the Office upon request and payment of the necessary fee.

FIG. 1 is a cross-sectional view of a colored mirror film (“CMF”) in accordance with some embodiments of this disclosure.

FIG. 2 is a cross-sectional view of a colored mirror film (“CMF”) having more than one optical package in accordance with some embodiments of this disclosure.

FIG. 3 is a cross-sectional view of a colored mirror film (“CMF”) having at least one embossment region in accordance with some embodiments of this disclosure.

FIGS. 4A and 4B are cross-sectional views of an authentication device in accordance with some embodiments of this disclosure.

FIGS. 5A through 5K are schematic illustrations of various optical effects achieved by some embodiments of this disclosure.

FIG. 6 is a cross-sectional view of an alternate authentication device in accordance with some embodiments of this disclosure.

FIGS. 7A - 7C are system drawings showing a method of embossing in accordance with some embodiments of this disclosure.

FIG. 8 is simplified system drawing of a method of applying laser energy to an authentication device in accordance with some embodiments of this disclosure.

FIG. 9 is a perspective view illustrating a method of using an authentication device in conjunction with a mobile computing apparatus according to some embodiments of this disclosure.

### DETAILED DESCRIPTION

This disclosure describes a security feature comprising a transparent colored mirror film (CMF) having a diffuse reflector on one surface and identifying print on an opposite surface in such a way that at least four different colors are produced during use in authentication applications.

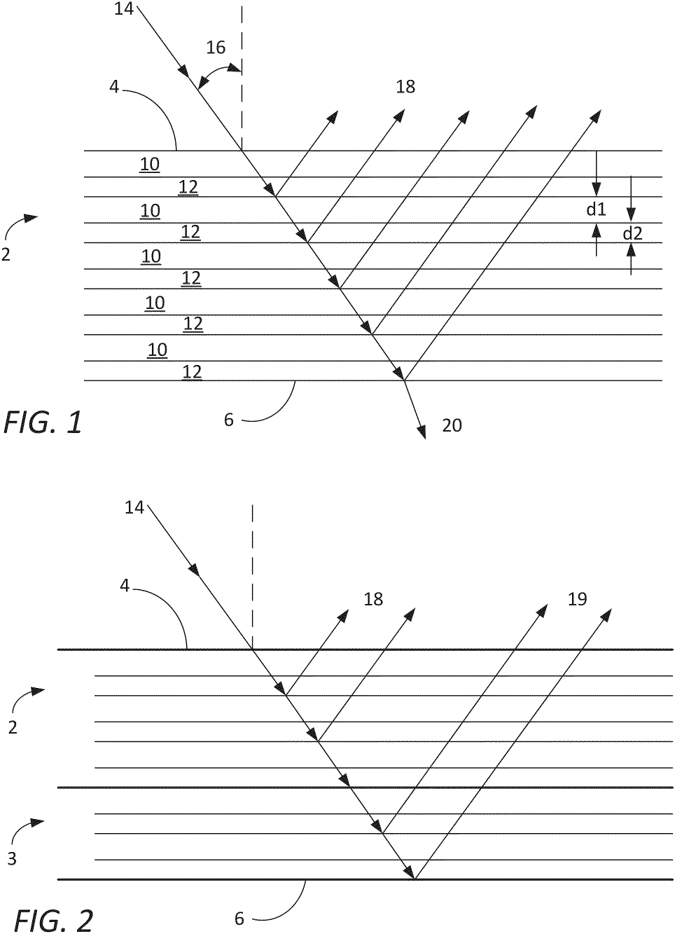

Colored mirror films (“CMFs”) are materials that comprise a number of alternating layers of material with at least two different indices of refraction. By controlling the index of refraction of the materials and the relative thickness of the layers, constructive and destructive interference will determine which wavelengths are reflected and which are transmitted. Equation 1, below, describes this effect with reference to FIG. 1, where n₁ and n₂ are the indices of refraction for alternating polymers 10 and 12, respectively, and where d₁ and d₂ are the thicknesses of the alternating layers of polymers 10 and 12, respectively.

$$\left(R e f l e c t e d W a v e l e n g t h\right) / 2 = {n}_{1} ∗ {d}_{1} + {n}_{2} ∗ {d}_{2} \qquad \text{Equation 1:}$$

For example, in FIG. 1, incident light 14, comprising broad spectrum white light, for example, arrives at a first surface 4 of a colored mirror film, CMF 2, at an incident angle 16, which is greater than a shift angle from normal. As further indicated in FIG. 1, the reflected light 18 that is reflected off first surface 4 will include light having a wavelength governed by the foregoing Equation 1. For incident light in the visible spectrum, the resultant reflected light 18 will thereby express a change in color corresponding to the wavelength resulting from Equation 1. As shown in FIG. 1, the component of the incident light 14 that is not reflected off of surface 4 is transmitted through the CMF 2, emerging as transmitted light 20 at second surface 6 of CMF 2 (opposite surface 4). This is described in U.S. Pat. No. 5,882,774 (“Jonza”).

If the reflected and transmitted light have wavelengths in the visible spectrum, they will appear to be one color in reflection and a different color in transmission. Typically, the reflected wavelengths of a CMF are the complementary colors of the transmitted wavelengths. If a large amount of the reflected light (greater than about 90%) is returned via this mechanism, the film is said to have high optical strength.

One interesting aspect of CMFs of sufficient optical strength, including some CMFs described in this disclosure, is that they can appear to be different colors when viewed straight on compared to off-angle. This is because the apparent thickness of the layers (which, as noted in FIG. 1, controls the wavelengths that are reflected) is different when viewed straight on versus when they are viewed obliquely. For example, a CMF that appears blue when viewed head-on (e.g., normal to a surface of the CMF) might appear a different color (e.g., green) when viewed from a sufficient angle from normal. Such CMFs are sometimes referred to as “color-shifting” CMFs.

The CMF 2 may be comprised of tens, hundreds, or even thousands of layers 10, 12 of optical materials (sometimes referred to as “microlayers”) to thereby form an interference stack having certain light reflection and transmission properties. The optical materials used to form the layers 10, 12 can be any suitable materials having the desired indices of refraction, and are commonly made of polymers, e.g., polyethylene naphthalate (PEN), polymethyl methacrylate (PMMA), polyethylene terephthalate (PET), acrylic, and other conventional polymer materials such as those disclosed in U.S. Pat. No. 5,882,774 (“Jonza”). The layers 10, 12 typically have an optical thickness that is a fraction of a wavelength of light and may be arranged in repeating patterns sometimes referred to as optical repeat units (ORUs).

One way of manufacturing a CMF is through the use of multilayer optical film (MOF) technology, which consists of coextruding two polymers of different indices of refraction. The 3 M Company, for example, produces a number of products that are made using MOF technology. By coextruding hundreds of microlayers using MOF technology, excellent CMFs can be manufactured. These kinds of CMFs can have very high optical strength and may include one or more “optical packages,” where, for example, one thickness section of the CMF might reflect one color, while another thickness section of the CMF might reflect a different color, so that the overall CMF (e.g., resulting from stacking the two sections onto each other) reflects a combination of the two colors. An example of the use of such “optical packages” is depicted in FIG. 2, where the CMF is shown having two thickness sections, CMF_{A} 2 and CMF_{B} 3. CMF_{A} 2 and CMF_{B} 3 may differ from each other, for example, by being formed of layers of differing materials with different indices of refraction, and/or differing thicknesses, etc. In the example shown in FIG. 2, the wavelength of reflected light 18 that would result from incident light 14 upon CMF_{A} 2 by itself might be governed by the following equation:

$$\left(\text{Reflected Wavelength}\right) / 2 = {\text{n}}_{1} {\text{*d}}_{1} + {\text{n}}_{2} {\text{*d}}_{2} ,$$

while the wavelength of reflected light 19 that would result from incident light 14 upon CMF_{B} 3 by itself might be governed by the following equation:

$$\left(\text{Reflected Wavelength}\right) / 2 = {\text{n}}_{3} {\text{*d}}_{3} + {\text{n}}_{4} {\text{*d}}_{4} ,$$

where one or more of the indices of refraction n₃, n₄ and/or the respective layer thicknesses d₃, d₄ may be different in CMF_{B} 3 than in CMF_{A} 2.

The net effect of each section (e.g., each optical package) of the CMF is to reflect light of different wavelengths such that, in the case of visible light, two colors would be reflected (e.g., red light from CMF_{A} 2 and yellow light from CMF_{B} 3). In this case, the apparent color of the reflected light to an observer of this effect may be a combination of the two colors (e.g., orange = red + yellow) corresponding to the combination of reflected light 18 from CMF_{A} 2 and reflected light 19 from CMF_{B} 3.

To manufacture an optical package such as depicted in FIG. 2, rather than “stacking” or placing the two films on top of each other, one could instead produce this effect by coextruding the many layers that form the CMF. For example, instead of forming the CMF by coextruding 256 layers of a single optical package, the CMF could be formed by simultaneously coextruding 128 layers of a first optical package CMF_{A} 2 and 128 layers of a second optical package CMF_{B} 3 in a single process.

In addition, some CMFs (including polymeric CMFs, for example) can be embossed with heat and/or pressure so that a different color may be observed in the regions of the embossments. For example, U.S. Pat. No. 6,788,463 (Merrill et al.), the contents of which are incorporated by reference herein in relevant part, describes the use of embossing a pattern in a multilayer polymer film to achieve varying color effects. Pressure may be applied selectively to a CMF using a tool such as an embossing die with raised embossments, to produce areas, zones, or patterns of embossment regions in the CMF. The resultant thinning in the embossment regions may produce a reduction in the thickness of the film by 5-10% or more. The localized or selective thinning produced by embossing may be effective throughout the thickness of the affected embossment regions such that substantially all of the optically thin layers (“microlayers”) comprising the CMF are also thinned (e.g., reduced thickness) within the embossment regions relative to neighboring, unembossed regions. Since the thickness of the microlayers is at least in part responsible for the observed reflective and transmissive characteristics, the embossment regions may result in a shifting of the reflection bands (e.g., the wavelengths of reflected light) to shorter wavelengths owing to the shortened optical path length in the microlayers (as described in Equation 1 above) resulting from the embossing process. An observer will perceive the embossment pattern due to the difference in reflected and/or transmitted color between the embossed and unembossed regions. The use of a CMF comprising polymeric films, for example, for the embossing applications described herein may facilitate producing an indelible embossment, thereby maintaining the durability of the optical effect produced.

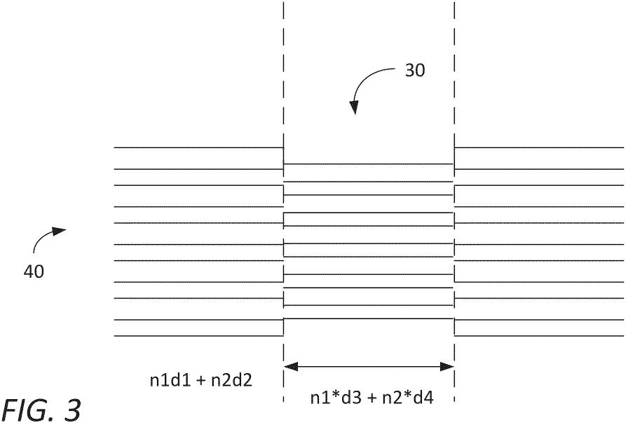

FIG. 3 illustrates the effect of embossing a CMF to achieve the above-described effect of different reflected or transmitted colors in different regions of the CMF (e.g., embossed versus unembossed). For example, where pressure and/or heat have been applied to a selected region of the CMF, as indicated at embossment region 30 in FIG. 3, the thickness of the many layers (microlayers) that form the CMF may change within the embossment region 30 (e.g., thinning or a reduction in thickness of the microlayers occurs in region 30) as compared to the relative thickness of the neighboring unembossed region(s) 40. It should be noted that a change in the index of refraction may also occur as a result of the embossing process (for example, from birefringence effects), but we have assumed that the net effect of this is small relative to the change in thickness. Thus, the wavelength of light reflected at an embossment region 30 may again be governed by Equation 1, with somewhat different values, d₃ and d₄, for the new thicknesses produced by the embossing process. In other words,

$$\left(\text{Reflected Wavelength}\right) / 2 = {\text{n}}_{1} {\text{*d}}_{3} + {\text{n}}_{2} {\text{*d}}_{4} ,$$

where the indices of refraction, n₁ and n₂, remain essentially the same (or substantially unchanged) in the embossed region 30 and the unembossed region 40, while the corresponding thicknesses, d₃ and d₄ in the embossed region 30, have changed from their original values, d₁ and d₂ in the unembossed region 40, due to the embossing process, causing the resultant reflected light wavelength to change accordingly.

As examples of embossing conditions that may be suitable for use according to some embodiments of this disclosure, the following exemplary conditions were used to produce the effects described above; however, these conditions are considered exemplary only, and many variations of these parameters could be employed by those of ordinary skill in the art to achieve comparable results. In some embodiments, an embossing press was used (e.g., such as that made by Delta ModTech^{®}, https://www.deltamodtech.com/, or comparable equipment), comprising unwind and rewind roller portions, and a “nip” formed between a smooth steel “anvil” roll and a second steel roll with raised embossments (a “pattern” roll).

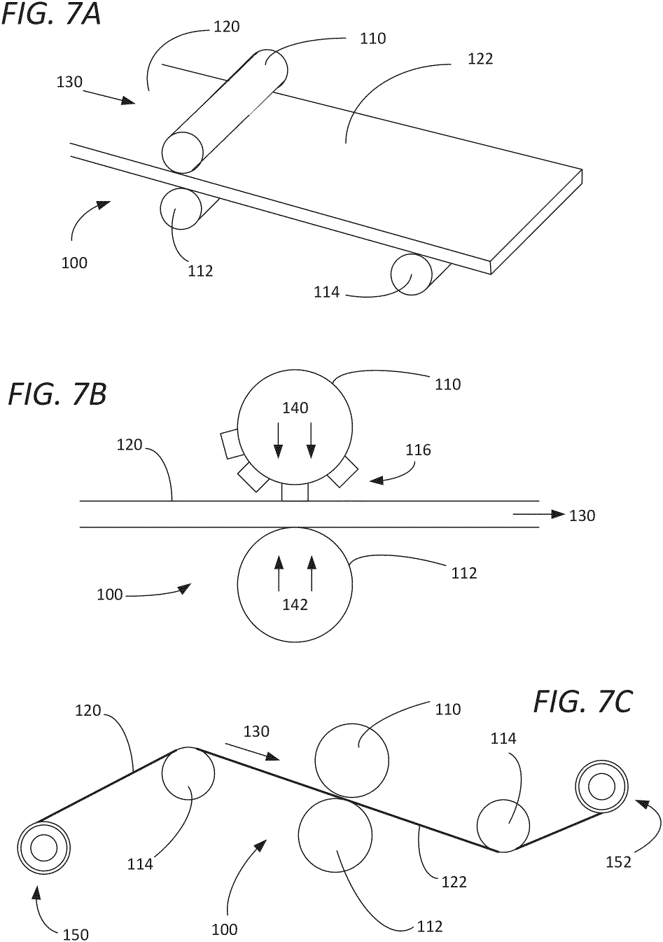

Reference is now made to FIGS. 7A - 7C, which illustrate, in general terms, a process for embossing a CMF. FIG. 7A is a schematic perspective view illustrating an exemplary process for embossing a CMF according to some embodiments. The process may involve two cylindrical, parallel rolls 110 and 112, positioned to form a “nip” 100 therebetween. Pattern roll 110 has raised artwork comprising protuberances 116 (see FIG. 7B) extending radially outward from the periphery of pattern roll 110. Anvil roll 112 is disposed beneath pattern roll 110 in FIGS. 7A and 7B, and has a surface which is generally smooth. In the example depicted, an extruded polymer sheet 120 is configured to move through the nip 100 at a speed and direction denoted by arrow 130. Pressure and heat applied by rollers 110 and 112 at nip 100 produce the embossed sheet 122 shown in FIG. 7A. One or more additional rollers 114 may be positioned as shown in FIGS. 7A and 7C to align sheet 120 and/or provide suitable tension, etc., during the embossing process.

Exemplary embossing conditions may include heating the anvil roll 112 to 250° F., and applying 2000 pounds of die pressure to both the anvil roll 112 and the pattern roll 110 using suitable embossing equipment (e.g., the aforementioned Delta ModTech^{®} press). The CMF sheet 120 to be embossed is moved from the unwind roller 150 at one end to the rewind roller 152 at the opposite end, passing through the nip 100 at the aforementioned conditions. A speed of 50 feet per minute (“FPM”) was employed, although this parameter is again exemplary only - other conditions of speed, heat, and pressure could be employed to produce comparable results. The pressure parameter of 2000 pounds may be applied by both the anvil and pattern rolls 112, 110 to result in a total of 4000 pounds applied at the nip 100. The result of the embossing process is an embossed CMF sheet 122 at the rewind roller 152 that will have a permanent indelible embossment that is a mirror image of the raised embossments on the pattern roll 110. The embossment regions of the CMF will produce different colors than the unembossed portions of the CMF, causing the pattern of embossment to be visible to an observer. Additional details of an example of the embossment process described above are provided with reference to Example 4 below.

An alternative approach to the embossment techniques described above may be found in Appendix A to this disclosure.

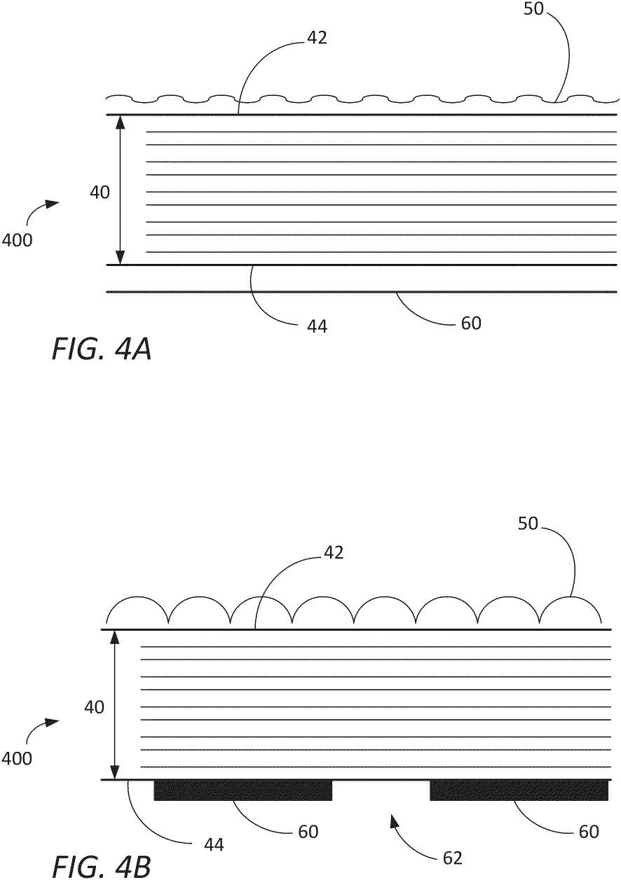

In one exemplary embodiment of an optical security feature disclosed herein, FIG. 4A shows security feature 400 comprising a CMF 40 having a diffuse reflector 50 disposed on at least a portion of a first surface 42 of the CMF 40, and having a print or reflector 60 disposed on at least a portion of a second surface 44 of CMF 40 opposite the first surface 42, as shown in FIG. 4A. The diffuse reflector 50 can cover part or all of the first surface 42 of CMF 40, and the print or reflector layer 60 disposed on second surface 44 could be opaque, as shown in FIG. 4A. Alternately, second surface 44 may have a layer disposed thereon comprising an arrangement of opaque portions 60 and transparent window portions 62 as shown in the security feature 400 of FIG. 4B. In some embodiments, the shape and placement of alternating opaque portions 60 and transparent window portions 62 may be employed to form graphic text characters, or logos, or other images, for example.

The use of a scattering layer such as diffuse reflector 50 is described in U.S. Pat. No. 9,995,861 (“Coggio”), the contents of which are incorporated by reference herein in relevant part. Coggio describes the use of a diffuse reflector or specular reflector, which is a light-scattering surface designed to prevent surface specular reflection.

The diffuse scattering layer can be affixed to the surface of the CMF via lamination or coating or adhesive or it can be temporarily placed on the CMF as an authentication device like a decoder. A non-scattering structure or film could first be affixed to a first surface of the CMF and then embossed in a subsequent operation using an embossing tool, for example in the fabrication of an ID document that involves lamination. The scattering layer would preferably be made from a transparent or semi-transparent polymer such as an acrylic, polystyrene, polyvinyl chloride, polycarbonate, or polyester. The scattering layer can be directional (e.g., lenticular structures that run along one axis) or non-directional (e.g., spherical or aspherical lenses) according to various embodiments of this disclosure.

The scattering layer 50 may comprise a non-refractive diffuse reflector in some embodiments. For example, the scattering layer 50 may be of a thickness and of a coarse structure so as to obviate the possibility of refractive or diffractive surface effects (e.g., having a size scale that substantially exceeds the wavelength of light).

The print layer on the device can be applied using a variety of techniques well known in the art such as printing via offset, inkjet, laserjet, flexographic, lithography, intaglio, screen, etc. The print layer can be applied directly on the CMF or there can be other layers or primers or coatings between the print and the CMF. The print does not need to occur on the CMF but it could be on an adjacent layer or substrate. The print can be unique to the security document or label such as a personalized image, or it could be a replicated feature such as a logo or design representative of the brand or country or any number of artwork designs.

Other security components, adhesives, layers, or coatings that are known in the art could be added to any surface. These components could be printed elements, diffractive structures, durable coatings, security fibers or threads, fragile tamper-indicating layers, taggants, micro-optics, security inks, laserable additives, and the like. These security components could feature either personalized or customized designs or artwork.

Some embodiments of this disclosure include incorporation into or onto a security document. Security documents may include, for example, passports, identification cards, drivers’ licenses, credit cards, currency, title documents, stock, marriage, or birth certificates, and security, warranty/fraud detection, or brand and asset protection labels among other security documents.

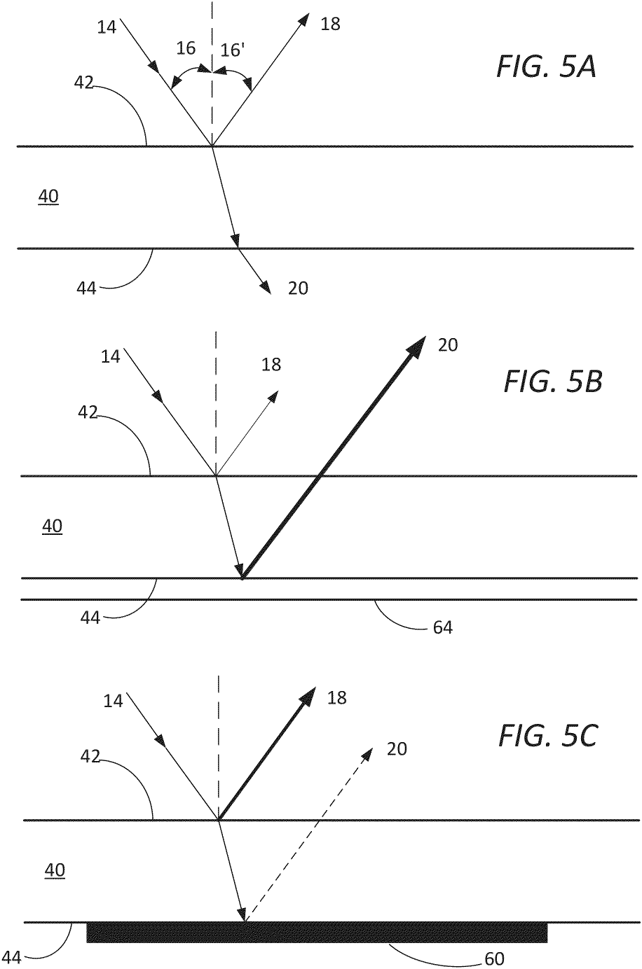

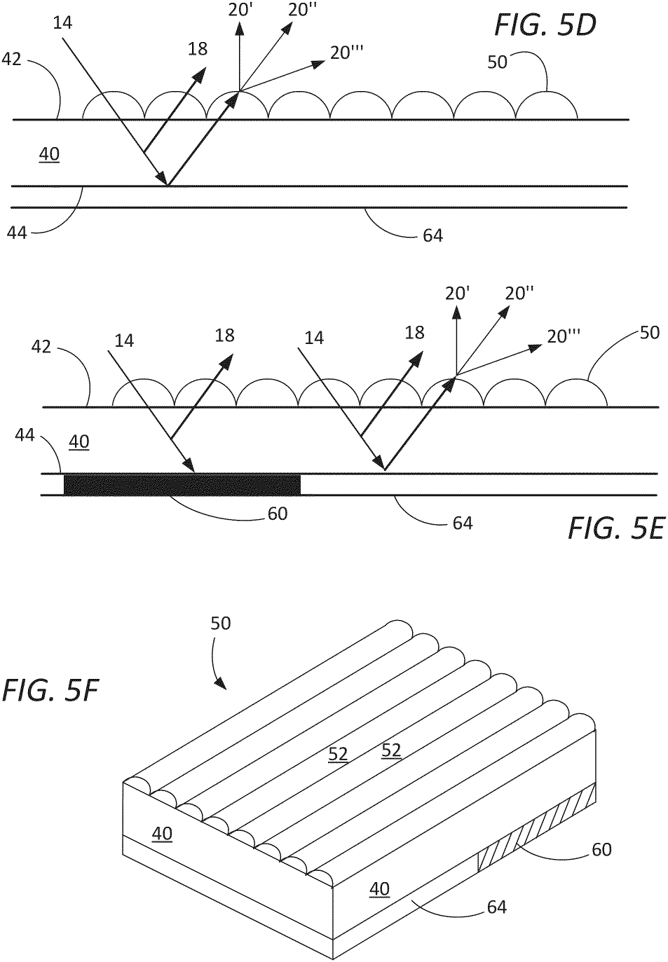

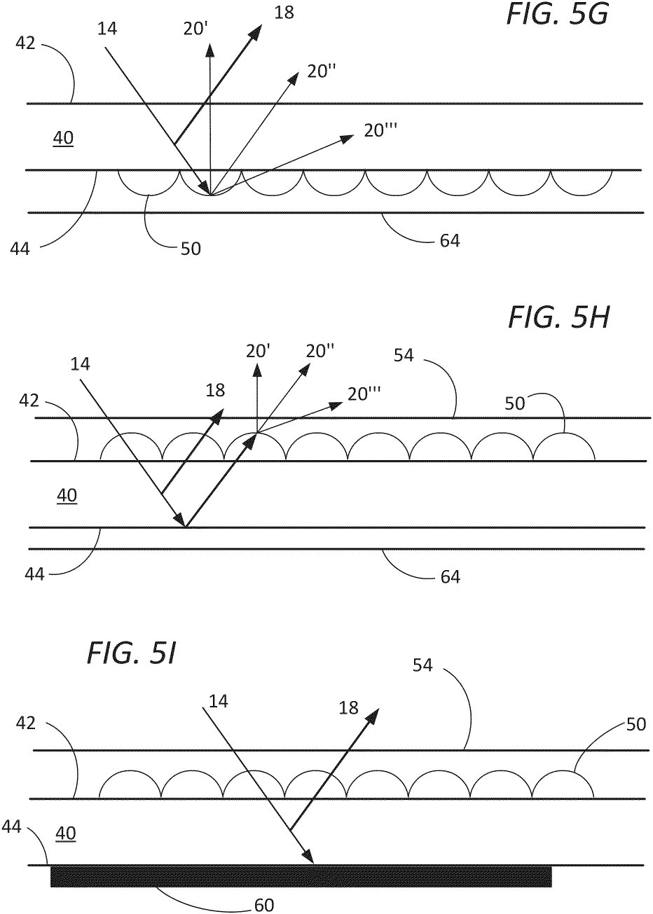

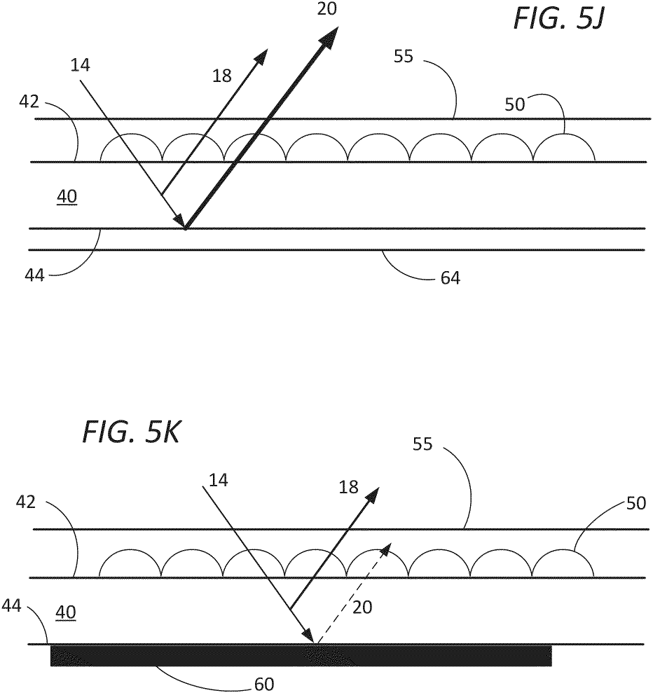

When viewed in reflection, the optical effect of a given CMF may be different depending on the incoming light and/or what is positioned behind (or in front of) the CMF, for example. FIGS. 5A - 5D illustrate how the optical effect may vary as the aforementioned parameters are varied. In FIG. 5A, for example, if the incoming light 14 arrives at a first surface 42 of a high optical strength CMF 40 at an incident angle 16, and an observer views the reflected light 18 at a matching angle 16′, then the reflected color (having a wavelength λ₂, as may be predicted by Eq. 1, above) will be apparent to the observer regardless of what is placed behind the CMF 40. The transmitted light 20 will pass through CMF 40 having a color corresponding to wavelength λ₁, as shown in FIG. 5A.

FIG. 5B illustrates the effect of diffuse lighting on CMF 40 when a white reflector 64 (e.g., a white film or print) is disposed on second surface 44 of CMF 40. In this scenario, the reflected light 18 having wavelength λ₂ will be relatively weak, as specular reflection could be reduced due to the diffuse lighting, whereas the transmitted light 20 having wavelength λ₃ (e.g., the light that would have otherwise been transmitted through CMF 40 in the absence of white reflector 64) will reflect off reflector 64 and is the dominant light seen by an observer. If the CMF 40 used in FIGS. 5A and 5B are the same, then wavelength λ₃ of FIG. 5B will equal wavelength λ₁ of FIG. 5A, and the apparent color to the observer in FIG. 5B will be the same as or similar to the color of the transmitted light 20 of FIG. 5A. With a white background, therefore, a CMF may appear to be its transmitted color rather than its reflected color.

Alternatively, if a dark or black film or print is disposed immediately behind the CMF 40 (e.g., a dark print layer 60 disposed on second surface 44) as shown in FIG. 5C, the transmitted light 20 in FIG. 5C will be absorbed (partially or fully) by layer 60, so that a relatively small portion of the light 20 of wavelength λ₃ (or none at all) may be reflected from layer 60. As a result, an observer will mainly see the reflected light 18 (of wavelength λ₂ in FIG. 5C) plus possibly some small contribution from the transmitted light 20 of wavelength λ₃ reflected off the back film layer 60, as shown in FIG. 5C. The color of the reflected light 18 of wavelength λ₂ is the dominant color observed in this scenario.

In one embodiment, a light scattering transparent diffuse reflector 50 is disposed on first surface 42 of CMF 40, as shown in FIG. 5D, to produce certain optical effects. In some embodiments, the diffuse reflector 50 may have a defined structure, like lenses for example, or could comprise a more random structure with non-uniform heights, shapes, and sizes, like a matte texture. An example of a diffuse reflector 50 having a defined structure is shown in the perspective view of FIG. 5F, where the surface of diffuse reflector 50 comprises a number of lenticular lenses 52. A diffuse reflector 50 may, in certain arrangements, operate to prevent or limit the transmitted light 20 from reaching an observer, so that the color of the reflected light 18 would tend to be the dominant color seen by an observer (e.g., wavelength λ₂ in FIG. 5D, where a white reflector 64 is disposed on second surface 44 of CMF 40). As shown in the example of FIG. 5D, the diffuse reflector 50 may cause the transmitted light 20 to be scattered, as shown by light components 20′, 20″, and 20‴, which enables the reflected light 18 to be the dominant color observed. Note that this produces a similar effect to that shown in FIG. 5C although the optical pathway may be different.

The observed effect described above with respect to FIG. 5D may be applicable to the case where the incident light 14 arrives from a direction that is generally perpendicular to the parallel rows of lenticular lenses, such as the lenticular lenses 52 illustrated in FIG. 5F. However, if the incident light 14 instead arrives from a direction that is generally parallel to the rows of lenticular lenses 52, the resultant effect will be more similar to that described with respect to FIG. 5B, and the dominant color observed will be that of transmitted light 20 having wavelength λ₃ rather than reflected light 18 of wavelength λ₂. This effect could be used to advantage by an observer (e.g., a person authenticating the item) by rotating the item 90 degrees in the same surface plane, and observing the change in color.

If lenticular lenses are used as the diffuse reflector 50, yet another interesting optical effect can be generated by rotating the device (e.g., rotating about an axis that is substantially normal to a planar surface of the device). As the lenses are rotational, the effect shown in FIGS. 5D and 5E would be observed in one orientation, while the effect shown in FIGS. 5B and 5C would be observed when the device is rotated approximately 90 degrees. The scattering surface could consist of alternating directional structures which could change as the surface is rotated, providing multiple color changes as the sample is rotated. This could also be achieved if a combination of directional and non-directional diffuse reflectors are used. For example, diffuse reflector 50 may comprise directional regions and non-directional regions. Additionally or optionally, diffuse reflector 50 may comprise multiple directional regions of differing directional orientations, for example the directional orientation in one region may be rotated some angle (e.g., 90 degrees) from the directional orientation of another region according to some embodiments.

Another interesting effect may be produced by “over-coating” the diffuse reflector 50 of FIG. 5D in selected regions or patterns to locally deactivate the above-described lens effect. For example, applying an over-coating layer (e.g., a thin coating, tape, or laminate) having an index of refraction that is very similar to the index of refraction of the diffuse reflector 50 (for example, the indices of refraction are within about 0.2 of each other), then the localized effect of the over-coating will deactivate the lens effect and result in the effect described with respect to FIG. 5B above (e.g., the color of transmitted light 20 of wavelength λ₃ will be the dominant effect observed). Thus, a pattern of localized deactivation of the lens effect would be made apparent to an observer. Such a pattern could be a recognizable shape or letter or logo, for example. If instead, the over-coating applied has an index of refraction that is sufficiently different from that of the diffuse reflector 50, for example a difference greater than about 0.2, then the lens effect would remain active (e.g., similar to FIG. 5D). An over-coat could be applied to some or all of the diffuse reflector 50 on a surface thereof, and, depending on the index of refraction of the coating, different optical effects can be produced. Examples of embodiments having over-coated lenses can be found in FIG. 5H - 5K.

In FIG. 5H, for example, an over-coating layer 54 is shown applied to diffuse reflector 50, and a white reflecting layer 64 is disposed on second surface 44 of CMF 40. Over-coating layer 54 in this example has an index of refraction that is different from that of the lenses of the diffuse reflector 50 in FIG. 5H. The net effect of this arrangement is similar to that described above with respect to FIG. 5D; that is, the reflected light 18 having wavelength λ₂ will be the dominant color presented to an observer. As noted above, the over-coating layer 54 has an index of refraction that is different from that of the lenses of diffuse reflector 50 by 0.2 or more.

In FIG. 5I, for example, an over-coating layer 54 is shown applied to diffuse reflector 50, and a dark print layer 64 is disposed on second surface 44 of CMF 40. Over-coating layer 54 in this example has an index of refraction that is different from that of the lenses of the diffuse reflector 50 in FIG. 5I. The net effect of this arrangement is similar to that described above with respect to FIG. 5E; that is, the reflected light 18 having wavelength λ₂ will be the dominant color presented to an observer. As noted above, the over-coating layer 54 has an index of refraction that is different from that of the lenses of diffuse reflector 50 by 0.2 or more.

In FIG. 5J, for example, an over-coating layer 55 is shown applied to diffuse reflector 50, and a white reflecting layer 64 is disposed on second surface 44 of CMF 40. However, the over-coating layer 55 in this example has an index of refraction that is similar to that of the lenses of the diffuse reflector 50 in FIG. 5J. The net effect of this arrangement is similar to that described above with respect to FIG. 5B; that is, the transmitted light 20 having wavelength λ₃ will be the dominant color presented to an observer. As noted above, the over-coating layer 55 has an index of refraction that is similar to that of the lenses of diffuse reflector 50 (e.g., within about 0.2).

In FIG. 5K, for example, an over-coating layer 55 is shown applied to diffuse reflector 50, and a dark print layer 60 is disposed on second surface 44 of CMF 40. The over-coating layer 55 in this example has an index of refraction that is similar to that of the lenses of the diffuse reflector 50 in FIG. 5K. The net effect of this arrangement is similar to that described above with respect to FIG. 5C; that is, the transmitted light 20 having wavelength λ₃ is absorbed (at least partially) by dark print layer 60, and reflected light 18 having wavelength λ₂ will be the dominant color presented to an observer. As noted above, the over-coating layer 55 has an index of refraction that is similar to that of the lenses of diffuse reflector 50 (e.g., within about 0.2).

As noted above, if the over-coat index of refraction is substantially different from that of the lenses comprising diffuse reflector 50 (e.g., the index of refraction difference is approximately 0.2 or greater), the optical effects produced by the structures shown in FIGS. 5H and 5I will appear similar to the optics demonstrated in FIGS. 5D and 5E. If, however, the index of refraction of the over-coat is similar to that of the lenses (e.g., the difference in index of refraction is less than about 0.2), the lens effect of the diffuse reflector 50 becomes disabled, and the optical effects shown in FIGS. 5J and 5K will appear similar to the optical effects demonstrated in FIGS. 5B and 5C.

An embodiment of this invention could have a surface featuring some active surface diffuse reflector elements, some active over-coated diffuse reflector elements, and some disabled diffuse over-coated reflector elements, or any combination of these. A mixture of active and disabled lenses would cause interesting combinations of colors. This mixture could be generated using a variety of known technologies; for example, an otherwise completely active diffuse reflector coating could be locally printed with an index-matching over-coating ink that would disable certain regions of the diffuse reflector, generating customized or personalized color schemes. Alternatively, a local application of a tape or adhesive could also disable some lenses while leaving other lenses active, generating the same effect. Yet another alternative approach could be to activate otherwise deactivated lenses via localized ablation or removal of an over-coat. The over-coat could include other security features, colorants, or components to achieve further customization or personalization.

In one embodiment, if portions of a CMF 40 have one or more diffuse reflectors 50 disposed on a first surface 42 of a CMF 40, and portions of the CMF 40 have printed, coated, or laminated regions comprising a multi-color layer on a second surface 44, then at least two colors will be presented to an observer at a normal observation angle, and at least two other colors will be presented to an observer at an oblique observation angle.

It should be noted that the construction shown in FIG. 5D would appear to be the color of the reflected light 18 when viewed over any opaque background when viewed from the top and would appear to be the color of the transmitted light 20 when viewed over a white background when viewed from the bottom, as the construction would appear to the viewer to be similar to FIG. 5B. Note that the optically interesting effect that is shown in FIG. 5D would also be achieved and/or observed if the diffuse reflector 50 were instead disposed between the white reflecting layer 64 and the CMF 40 such that the diffuse reflector 50 would diffusely scatter the light reflected from reflective layer 64, as illustrated in the example shown in FIG. 5G.

FIG. 5E also shows an embodiment having a diffuse reflector 50 disposed on a first surface 42 of CMF 40, and both light and dark print layers 64, 60 disposed on a second surface 44 of CMF 40.

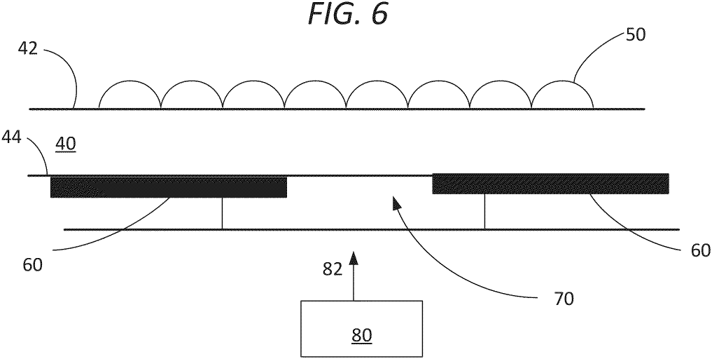

In an alternate embodiment, an open, transparent window 70 is disposed on an opposite surface from an observer (opposite print layer 60 in the example shown in FIG. 6). In this example, different colors may be presented to an observer depending on what is placed behind the window 70. For example, if an opaque (white or dark or anywhere in between) film is placed immediately behind the window 70 in FIG. 6, the feature would work the same as described above with respect to FIG. 5D and the reflected color would be observed and any print layer 60 would be very difficult to see. However, if a light source 80 were placed behind the window 70, for example allowing light 82 to travel through window 70 and toward a viewer/observer facing the diffuse reflector layer 50, the viewer/observer would see the transmitted color instead of the reflected color and the print layer would be considerably easier to see. Therefore, a simple authentication device could comprise, for example, a mobile phone (e.g., a “smart” phone, or a tablet, or a similar mobile computing device) with a light (white) portion image and a dark (black) portion image presented on the screen of the mobile device. When the document shown in FIG. 6 is placed over the dark portion of the image, the reflected light wavelength would be observed; when the document shown in FIG. 6 is placed over the light portion of the image (which is, in this case, emitted light from the phone or mobile device), the transmitted wavelength would be observed.

### Example 1

“Blaze™” CMF is an example of a color-shifting film made by the 3M™ Company. (NOTE: Although the examples that follow were produced using the Blaze™ CMF, there are other suitable CMF products available that could be employed in these examples and which would produce comparable results.) Blaze CMF appears to be cyan colored in transmission and red in reflection when viewed at normal angles, and which changes when tilted (e.g., when viewed at a shift angle from normal) to magenta and yellow colors in transmission and reflection, respectively. For Example 1, a PET sheet with lenticular lenses coated on one side and adhesive on the other was adhered to a first surface of the Blaze CMF. When placed over a white surface, Example 1 appears to be red. Upon tilting, the color changes to yellow. When placed over a black surface, Example 1 appears to be red. Upon tilting over a black surface, the color changes to yellow. When viewed with white backlighting (e.g., in transmission), Example 1 appears to be cyan. Upon tilting, the color changes to magenta.

### Example 2

A PET sheet with lenticular lenses coated on one side and adhesive on the other was applied to some regions on a first surface of Blaze CMF, while other regions of the first surface did not have the lenticular lens structure applied. When placed over a white surface, Example 2 appears to be red in regions covered by lenses and cyan when viewed in regions with no lens coverage. Upon tilting, the color changes to magenta in the lensed regions and yellow in the un-lensed regions. Over a white or lightly colored surface, at least four colors are generated with Example 2 when viewing the lensed and un-lensed regions. When placed over a black or dark surface, Example 2 appears to be entirely red. Upon tilting over a black surface, the color changes to yellow. When viewed with white backlighting (e.g., in transmission), Example 2 appears to be entirely cyan, similar to Example 1. Upon tilting, the color changes to entirely magenta, also similar to Example 1.

### Example 3

A sheet of Blaze CMF was printed on one surface using flexographic printing with black ink forming a pattern. A PET sheet with lenticular lenses coated on one side and adhesive on the other was adhered to the opposite surface of the Blaze CMF. Example 3 performs like Example 2 except that the dark, printed regions are difficult to see under the lenses but become much more visible when not under the lenses or when placed over a white background. The black printed regions (“artwork”) were invisible when placed over a black background. In transmission, the optical effect of the black artwork was very pronounced. This effect would readily lend itself to authentication applications where the item of Example 3 can be placed over a background that is alternately dark or black in regions, and white or lighted in other regions.

### Example 4

A sheet of Blaze CMF was embossed with artwork raised on a steel tool. In the particular example produced, the artwork resembled a globe with latitudinal and longitudinal lines raised on a steel tool. Conditions for embossing were 250° F., 2000 pounds of die pressure, running at a speed of 50 feet per minute (FPM) using a roll-to-roll operation on a Delta press. The Blaze CMF was indelibly marked with a mirror image of the embossed features using the above-described embossing conditions such that a different color (a light yellow color) was apparent in both reflection and transmission. The embossments, and the resultant change in the color-shifting aspects in the embossed regions of the CMF, were visible in the Blaze CMF even after applying a printed layer, or following application of a lenticular lens layer to the first and/or second surfaces of the CMF as described in Examples 1 and 3 above, providing an additional optical security feature aspect.

FIGS. 7A - 7C, which were described in detail above, illustrate in general terms a process for embossing a CMF to produce the effect described in Example 4 above. The extruded polymer sheet 120 described with respect to FIGS. 7A - 7C earlier comprised Blaze CMF in producing the effect described in Example 4. The conditions used for embossing to produce the effect of Example 4 were 250° F., 2000 pounds of die pressure, running at a speed of 50 feet per minute (FPM).

### Example 5

Security labels were formed from the sheets generated in Examples 1 through 4 by applying a transparent pressure-sensitive adhesive to the second surface (e.g., the non-lensed side) of the Blaze CMF. In some embodiments, the adhesive may be used to affix the security label to a document or item to be authenticated. In alternate embodiments, the adhesive may be placed between the CMF and a print layer, and would produce the same effect. The security labels produced in this manner generated the optical effects described above with respect to Examples 1 through 4. An example of a pressure sensitive adhesive that may be used in the manner described above is WCP 2242 acrylic adhesive (made by Wausau Coated Products). Other suitable adhesives for this example would be readily apparent to one of ordinary skill in the art with the benefit of these teachings.

### Example 6

A sheet of Blaze CMF was embossed as described in Example 4 above and made into labels as described in Example 5 above, without lenses on the surface. These labels were incorporated within a polycarbonate (PC) stack consisting of layers of clear PC film and converted into polycarbonate cards The PC used to form the PC stack was Rowland PC1-001-2600 made by Rowland Advanced Polymer Films, and the adhesive used to adhere the Example to the PC prior to lamination was CRL WJ47 adhesive (a heat-activated adhesive made by Crown Roll Leaf). The incorporation of the techniques and results of Examples 4 and 5 into a PC stack followed by standard PC lamination did not affect the optical effects appreciably. Additionally, the lens structure described above with respect to Example 2 (e.g., regions with and without the lensed surface) was applied to the surface, and the optical effect of Example 2 was repeated with this construction.

### Example 7

Blaze CMF security labels were formed as described above in Example 5, and were then “imaged” using a UV laser. Laser energy was applied to a surface of the label in focused areas (e.g., to form patterns, shapes, text, logos, etc.). Laser energy applied in this manner caused localized melting of the layers of the CMF, which changed the index of refraction and the thickness of the affected polymer layers, resulting in a change in the color effect at the localized areas affected.

In the examples produced, a Keyence UV laser (Model MD-U1000) was used to apply laser energy. When applying laser energy to a pressure sensitive adhesive label (PSA label), the following laser settings were employed to achieve the noted effects:
Laser Power: 100%
Scan Speed: 700
Pulse Frequency: 40
Spot Variable: -20
When applying laser energy to the PC card of Example 6, the following laser settings were employed to achieve the noted effects:
Laser Power: 100%
Scan Speed: 1150
Pulse Frequency: 40
Spot Variable: -3

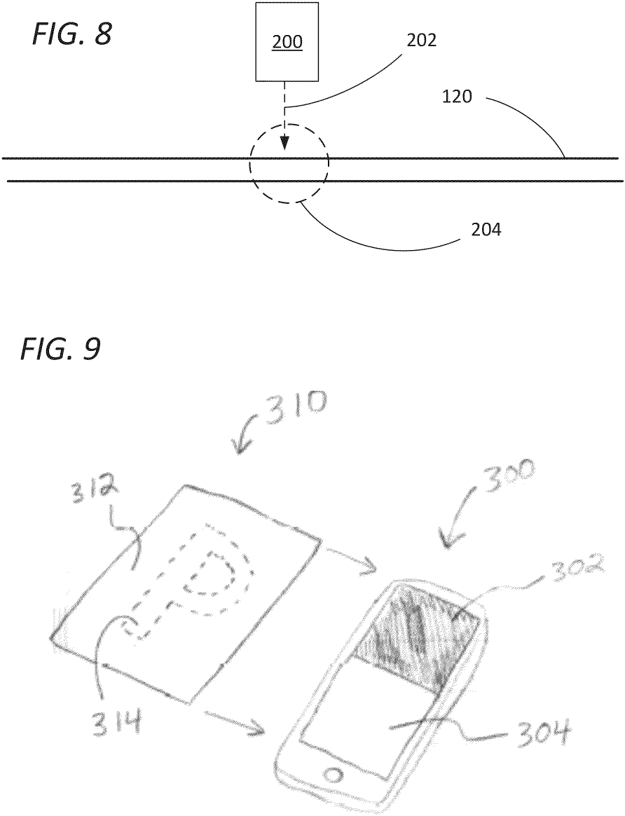

FIG. 8 is a schematic diagram illustrating a laser apparatus for applying laser energy to a security label as described above with respect to Example 7. Laser energy source 200 is shown in FIG. 8 applying laser energy 202 to a localized area 204 of security label 120 to produce the desired changes in index of refraction and thickness, and the accompanying changes in optical color-shifting effect. A pattern formed by the application of laser energy in this manner (e.g., text, logo, shape, etc.) may comprise an additional aspect of authentication provided by this example, according to some embodiments.

### Example 8

This example is similar in construction to that shown in FIG. 5G, where the diffuse reflector is an embedded, largely colorless transparent hologram made by Crown Roll Leaf, Inc., which was affixed to the second surface (backside) of a sheet of Blaze CMF via a hot melt stamping method. WCP 2242 acrylic adhesive made by Wausau Coated Products was applied to the back side of the hologram, and this label was affixed to a black card. The holographic structures affected the optics, as the label appeared red in regions without the hologram, while the otherwise largely colorless hologram appeared cyan in color due to the CMF. The colors switched to yellow and magenta in the non-hologram/hologram portions, respectively, demonstrating that the scattering surface can be on the opposite side of the CMF (e.g., the second surface) from the viewer and still produce the same optical effect.

### Example 9

Using a “smartphone” (Apple iPhone X), a half-white, half-black image was produced on the screen. The structure formed in Example 3 above was placed over the black half of the image, and the entire label appeared to be like Example 3 over a black surface, including hidden print. When placed over the white half of the image, this example appeared to be like Example 3 in transmission. This gave the print an on-again, off-again appearance using this technique, which would lend itself well for use in authentication scenarios using readily available mobile phone technology.

FIG. 9 illustrates the above-described authentication scenario of Example 9. Label 310 in FIG. 9 is formed according to Example 3 (see also FIG. 4B) such that a diffuse reflector 312 is disposed on a first surface of a CMF layer (not shown) such that it faces an observer, and a print layer 314 is disposed on a second surface of the CMF. Smartphone 300 is shown producing an image comprising a dark portion 302 and a white portion 304. When label 310 is placed over smartphone 300 while producing the white and dark images 304 and 302, the optical effects will be as described for Example 9, thus providing a readily available means for authenticating documents or other items.

Various examples have been described. These and other variations that would be apparent to those of ordinary skill in this field are within the scope of this disclosure.

What is claimed is:

1. An authentication device comprising:
a colored mirror film (“CMF”) layer having a first major surface and a second major surface opposite the first major surface, the CMF layer comprising a multilayer optical film extending from the first major surface to the second major surface, the multilayer optical film comprising alternating first and second optical polymeric layers, each of the first optical polymeric layers having a first refractive index, and each of the second optical polymeric layers having a second refractive index different from the first refractive index;
a scattering layer disposed on at least a portion of the first major surface of the CMF layer; and
a print layer disposed on the second major surface of the CMF layer,
wherein at least four distinct colors become visible to an observer positioned adjacent the scattering layer as the authentication device is tilted from a normal angle to the observer to a shift angle from the observer.

2. The authentication device of claim 1 wherein the scattering layer is transparent.

3. The authentication device of claim 1 wherein the scattering layer is a non-diffractive diffuse reflector.

4. The authentication device of claim 1 wherein the print layer comprises a document to be authenticated.

5. The authentication device of claim 1 wherein the authentication device further comprises a transparent window disposed on the print layer.

6. The authentication device of claim 1 further comprising a layer of localized over-coating disposed on an outer surface of the scattering layer, the over-coating layer having a refractive index that is within 0.2 of the refractive index of the scattering layer.

7. The authentication device of claim 1 further comprising a layer of localized over-coating disposed on an outer surface of the scattering layer, the over-coating layer having a refractive index that is different from the refractive index of the scattering layer by at least 0.2.

8. The authentication device of claim 1 further comprising one or more embossment regions.

9. The authentication device of claim 8 wherein the CMF comprises one or more embossment regions.

10. The authentication device of claim 9 wherein the embossment regions of the CMF produce a different color effect than the unembossed regions.

11. The authentication device of claim 1 wherein the scattering layer is formed by embossing a transparent polymer disposed on a first surface of the CMF.

12. The authentication device of claim 1 further comprising one or more regions in which laser energy has been applied to form a varying optical effect.

13. The authentication device of claim 1 wherein the scattering layer comprises a first region having a directional diffuse reflector.

14. The authentication device of claim 13 wherein the scattering layer further comprises at least one region having a non-directional diffuse reflector.

15. The authentication device of claim 13 wherein the scattering layer further comprises a second region having a directional diffuse reflector, wherein the directional orientation of the second region is different from the directional orientation of the first region.

16. The authentication device of claim 13 wherein at least four distinct colors become visible to an observer positioned adjacent the scattering layer as the authentication device is rotated 90 degrees in a surface plane.

17. The authentication device of claim 1 wherein the scattering layer forms a pattern that only partially covers the first major surface of the CMF layer.

18. An authentication device comprising:
a colored mirror film (“CMF”) layer having a first major surface and a second major surface opposite the first major surface, the CMF layer comprises a multilayer optical film extending from the first major surface to the second major surface, the multilayer optical film comprising alternating first and second optical polymeric layers, each of the first optical polymeric layers having a first refractive index, and each of the second optical polymeric layers having a second refractive index different from the first refractive index; and
a transparent scattering layer disposed on the second major surface of the CMF layer;
wherein the authentication device is configured to be applied to a surface of an item to be authenticated, and wherein at least four distinct colors are displayed to an observer by the authentication device as the item is tilted from a normal angle to a shift angle.

19. The authentication device of claim 18 wherein the item to be authenticated comprises a print layer having light portions and dark portions, and wherein the authentication device is adhered to the print layer such that the transparent scattering layer is sandwiched between the CMF and the print layer.

20. A method of authenticating an item having a security device, the method comprising:
generating a screen image comprising a light portion and a dark portion;
placing the security device over the dark portion of the screen image and observing a first color at a substantially normal viewing angle, and observing a second color at a viewing angle tilted from a normal viewing angle;
placing the security device over the light portion of the screen image and observing a third color at a substantially normal viewing angle, and observing a fourth color at a viewing angle tilted from a normal viewing angle;
wherein the security device comprises:
a colored mirror film (“CMF”) layer having a first major surface and a second major surface opposite the first major surface, the CMF layer comprises a multilayer optical film extending from the first major surface to the second major surface, the multilayer optical film comprising alternating first and second optical polymeric layers, each of the first optical polymeric layers having a first refractive index, and each of the second optical polymeric layers having a second refractive index different from the first refractive index;
a transparent scattering layer disposed on either the first major surface or the second major surface of the CMF layer; and
a print layer disposed on the second major surface of the CMF layer if the scattering layer is disposed on the first major surface of the CMF layer, or adjacent the scattering layer if the scattering layer is disposed on the second major surface of the CMF layer.

21. The method of claim 20 wherein the screen image is generated using a mobile computing device.

22. The method of claim 20 wherein the step of placing the security device over the light portion of the screen image is performed before placing the security device over the dark portion of the screen image.

23. The method of claim 20 wherein the light portion of the screen image is similar in size and shape to the dark portion of the screen image.

24. The method of claim 20 wherein the transparent scattering layer is disposed on the second major surface of the CMF layer.

25. The method of claim 20 wherein the security device further comprises a transparent window disposed on the print layer proximate to the second major surface of the CMF.

26. A method of manufacturing a security document comprising:
providing a colored mirror film (“CMF”) layer having a first major surface and a second major surface opposite the first major surface, the CMF layer comprising a multilayer optical film extending from the first major surface to the second major surface, the multilayer optical film comprising alternating first and second optical polymeric layers, each of the first optical polymeric layers having a first refractive index, and each of the second optical polymeric layers having a second refractive index different from the first refractive index;
applying a print layer to the second major surface of the CMF layer;
applying a diffuse reflector layer to the first major surface of the CMF layer; and
incorporating the CMF layer, the print layer, and the diffuse reflector layer into a security document, wherein at least four distinct colors become visible to an observer positioned adjacent the diffuse reflector layer as the security document is tilted from a normal angle to the observer to a shift angle from the observer.

27. A method of manufacturing a security document comprising:
providing a colored mirror film (“CMF”) layer having a first major surface and a second major surface opposite the first major surface, the CMF layer comprising a multilayer optical film extending from the first major surface to the second major surface, the multilayer optical film comprising alternating first and second optical polymeric layers, each of the first optical polymeric layers having a first refractive index, and each of the second optical polymeric layers having a second refractive index different from the first refractive index;
applying a print layer to the second major surface of the CMF layer;
incorporating the CMF layer and the print layer into a security document; and
applying a diffuse reflector layer to a surface of the security document adjacent the first major surface of the CMF layer, wherein at least four distinct colors become visible to an observer positioned adjacent the diffuse reflector layer as the security document is tilted from a normal angle to the observer to a shift angle from the observer.

28. The method of claim 27 wherein the diffuse reflector layer is applied to the surface of the security document using a lamination process.

29. The method of claim 27 wherein the diffuse reflector layer is applied to the surface of the security document using an embossing process.
